(19) United States
(12) Patent Application Publication
(10) Pub. No.: US 2017/0058175 A1
(43) Pub. Date: Mar. 2, 2017

(54) MATERIALS WITH ENHANCED THERMAL CAPABILITY UNDER TRANSIENT HEAT LOAD

(71) Applicant: SABIC GLOBAL TECHNOLOGIES B.V., Bregen op Zoom (NL)

(72) Inventor: Steven Marc Gasworth, Wixom, MI (US)

(21) Appl. No.: 15/119,554

(22) PCT Filed: Feb. 18, 2015
(86) PCT No.: PCT/IB2015/051251

§ 371 Date: Aug. 17, 2016

Related U.S. Application Data
(60) Provisional application No. 61/940,938, filed on Feb. 18, 2014.

(51) Int. Cl. C09K 5/06; B29C 45/16; B29C 45/72; C08J 5/12

(52) U.S. Cl. CPC C09K 5/063; C08J 5/121; B29C 45/16; B29C 45/7207; C08J 2300/12; B29K 2105/0047

(57) ABSTRACT

In an embodiment a method of making an article, comprises: forming the article comprising a first portion comprising a polymer composition and a second portion, wherein a composition of the first portion and of the second portion are different; and processing the article at a manufacturing temperature that is greater than a Temperature A, wherein Temperature A is at least one of the heat deflection temperature, the glass transition temperature, the melting temperature, and the degradation temperature; wherein the first portion comprises at least one of (a) the polymer composition in the form of a filled, channeled structure and (b) a phase change material; wherein during the processing, an average temperature of the polymer composition is maintained below Temperature B, wherein Temperature B is at least one of the heat deflection temperature, the melting temperature, the glass transition temperature, and the degradation temperature.

### TECHNICAL FIELD

The present disclosure relates to articles with improved resistance to transient heat loads, and methods for making the same.

### BACKGROUND

Polymers have mechanical, physical, and chemical properties that are useful in a wide variety of applications. One manner, in which polymer compositions can be classified for their use, is by characterizing their heat deflection temperature (“HDT”). The HDT denotes the upper limit temperature at which a polymer composition can support a specified load for any appreciable time or, in other words, the upper temperature limit at which the polymer composition can be used as a rigid material. Some polymer compositions that would otherwise be suitable for an application in service, where the HDT of the polymer composition is greater than the temperature the polymer composition would experience during service, can be precluded from use if the manufacturing process associated with the application would even temporarily subject the polymer composition to ambient temperatures exceeding the HDT of the polymer composition.

An example of a process that utilizes manufacturing temperatures above the HDT of polymer compositions within the article is in automobile manufacturing. In the manufacturing of automobiles, most polymer compositions are inhibited from use in the body-in-white as they cannot tolerate the transient heat load conditions of the paint-bake cycle whose temperature range is from 170 to 200 degrees Celsius (° C.) with durations ranging from 20 to 30 minutes. Also, in welding applications, polymer compositions can be excluded from use as the welding temperature can result in deformation of the polymer composition around the welding location Likewise, polymer compositions in the proximity of a metal soldering process can be inhibited from use where temperatures can be as much as 400° C. with durations as long as 5 minutes as such high temperatures can be above the glass transition temperature, the melting temperature, and/or the degradation temperature of the polymer composition. In the paint-bake example, materials with HDTs below the transient high temperature of the paint-bake cycle would be subject to deformation and in the welding and soldering examples, materials with a glass transition temperature, melting temperature, and/or degradation temperature below the temperature they attain in the proximity of the joining location would be subject to melting or possible degradation.

Likewise, some composite materials can be precluded from use if the manufacturing process utilizes ambient temperatures that are incompatible with one or more of the components; for example, if either the fiber or the resin matrix (such as a fiber-reinforced polypropylene whose HDT is about 158° C.) could not withstand the ambient temperatures of the manufacturing process (e.g. paint-bake cycle). Although this HDT value is greater than the in-service temperature the automobile would experience after being manufactured, it is below the typical range of the paint-bake cycle.

A secondary problem that arises if there is a difference in the coefficient of thermal expansion between the polymer composition and the adjacent material, e.g., when the polymer composition is mechanically constrained by another material (e.g., a metal) that undergoes significantly less thermal expansion. The difference thermal expansion during the high temperature manufacturing process can cause the introduction of thermally induced stress between the two materials. For this reason and for the above-mentioned reasons, materials that would otherwise be attractive for use in an application, whose maximum in-service temperature is below the HDT or the melting temperature of the material, might not be adopted into such a use due to the thermal limitation manifested only during the manufacturing event.

Accordingly, there remains a need for additional manufacturing techniques that enable the use of materials whose HDT or a melting temperature are sufficient for the use application, but are less than that needed to withstand a temperature imposed by the manufacturing process. There remains a need in the art to enable materials with an HDT or a melting temperature that is less than a temperature imposed by the manufacturing process to be able to withstand such temperatures.

### SUMMARY

Disclosed herein are methods of making articles and articles made therefrom.

In an embodiment, a method of making an article can comprise: forming the article comprising a first portion comprising a polymer composition and a second portion comprising a material, wherein the polymer composition has at least one of a heat deflection temperature, a melting temperature, a degradation temperature, and a glass transition temperature; and processing the article at a manufacturing temperature that is greater than a Temperature A, wherein the Temperature A is at least one of the heat deflection temperature, the melting temperature, the glass transition temperature, and the degradation temperature; wherein the polymer composition has a filled, channeled structure and/or wherein the article comprises a phase change material, wherein the presence of one or both of the filled, channeled structure and the phase change material maintains an average temperature of the polymer composition below Temperature B during the processing, wherein Temperature B is at least one of the heat deflection temperature, the melting temperature, the glass transition temperature, and the degradation temperature.

In another embodiment, a method of making an article can comprise: forming the article comprising a first portion comprising a polymer composition and a second portion, wherein the polymer composition has at least one of a heat deflection temperature, a glass transition temperature, a melting temperature, and a degradation temperature, and wherein a composition of the first portion and of the second portion are different; and processing the article at a manufacturing temperature that is greater than a Temperature A, wherein the Temperature A is at least one of the heat deflection temperature, the melting temperature, the glass transition temperature, and the degradation temperature; wherein the first portion comprises at least one of (a) the polymer composition in the form of a filled, channeled structure and (b) a phase change material; wherein during the processing, (i) an average temperature of the polymer composition is maintained below Temperature B, wherein Temperature B is at least one of the heat deflection temperature, the melting temperature, the glass transition temperature, and the degradation temperature; and/or (ii) greater than or equal to 50% of the polymer composition volume is maintained below Temperature B, wherein Temperature B is at least one of the heat deflection temperature, the melting temperature, the glass transition temperature, and the degradation temperature.

The above described and other features are exemplified by the following Figures and Detailed Description.

### BRIEF DESCRIPTION OF THE DRAWINGS

The following is a brief description of the drawings which are presented for the purposes of illustrating the exemplary embodiments disclosed herein and not for the purposes of limiting the same.

FIG. 1 is a graphical illustration of the resultant temperature of a polymer composition with and without a phase change material with increasing stored heat;

FIG. 2 is an illustration of an embodiment of a low HDT material comprising a PCM located throughout the sample;

FIG. 3 is an illustration of an embodiment of a low HDT material comprising a PCM in a region proximal to the outer surface of the low HDT material;

FIG. 4 is an illustration of an embodiment of a low HDT material with a PCM layer;

FIG. 5 is an illustration of an embodiment of a low HDT material with a PCM layer and an interlayer between the HDT material and PCM layer;

FIG. 6 is an illustration of an embodiment of a low HDT material with a PCM layer comprising a gradient PCM and an interlayer there between;

FIGS. 7-9 are illustrations of embodiments of a polymer composition structure comprising channels; and

FIG. 10 is an illustration of an embodiment of an article comprising a first portion (comprising a polymer composition structure comprising channels) and a second portion comprising the material.

### DETAILED DESCRIPTION

Polymers have been precluded from use in manufacturing processes that utilize ambient temperatures that are incompatible with the polymer composition. For example, in automobile manufacturing, most polymer compositions are inhibited from use in the body-in-white as they cannot tolerate the transient heat load conditions of the paint-bake cycle whose temperature range can be 170 to 200° C. with durations of 20 to 30 minutes. In polymer composition welding applications, polymer compositions can be excluded from use as the welding temperature can result in deformation of the polymer composition around the welding location. Likewise, polymer compositions in the proximity of a metal soldering process can be inhibited from use where temperatures can be as much as 400° C. with durations as long as 5 minutes. These high temperatures can be above one or more of the glass transition temperature, the melting temperature, and the degradation temperature of the polymer composition. It was surprisingly discovered that articles comprising a polymer composition and another material, wherein the polymer composition has a filled, channeled structure (also referred to herein as a polymer composition structure) and/or wherein the article comprises a phase change material can withstand a manufacturing temperature that is greater than at least one of the polymer compositions: heat deflection temperature, the melting temperature, and the degradation temperature, and glass transition temperature. In applications such as automobile manufacture, the ability to incorporate polymer composition components, for example, to replace metal components can beneficially result in an overall weight reduction.

The article can comprise a phase change material (PCM). The PCM can prevent the polymer composition from attaining an average temperature above its HDT. As used herein, the HDT is determined in accordance with ASTM D648-98c. wherein a test specimen is loaded into three-point bending in the edgewise direction and the temperature is increased at 2° C./min until the specimen deflects 0.25 mm, with an outer stress used for testing of 1.82 MPa. A further benefit of the PCM can be a reduced thermal expansion of the polymer composition during exposure to a high temperature of the manufacturing process, as the PCM can reduce the average peak temperature attained by the polymer composition. The PCM can be based on a solid-liquid phase change, as there is a relatively small volume change associated with the transition from solid to liquid and back. The PCM can further be encapsulated to prevent leakage of the liquid PCM into the polymer composition.

The PCM can maintain an average temperature within a desired range that is below a temporarily elevated ambient temperature (also referred to as the manufacturing temperature), more specifically, it can maintain a temperature of the polymer composition at a temperature below one or more of an HDT of the polymer composition, a melting temperature of the polymer composition, a glass transition temperature of the polymer composition, and a degradation temperature of the polymer composition. As used herein the degradation temperature of the polymer composition means a temperature above which the polymer composition experiences one or more of a blackening in color, a change in the average molecular weight, a carbonization, and a change in the atomic composition of the polymer composition. Maintaining a lower average temperature allows the polymer composition to bear the elevated ambient temperature that is needed to manufacture the second material and that would otherwise preclude use of the polymer composition due to, for example, potential melting and/or degradation.

The PCM undergoes a phase change at a characteristic phase change temperature to absorb or release energy as latent heat without a substantial change in temperature until the phase change is complete. In other words, the temperature change of a material comprising a PCM is less than the temperature change of the same material that is free of the PCM when storing or releasing the same energy over a temperature range that includes the phase change temperature. When a polymer composition comprises a PCM, the PCM material can absorb heat at constant temperature during its phase change, which can help to maintain the temperature of the polymer composition below its HDT. As compared to a polymer composition without a PCM, for which heat is stored exclusively in a sensible form (i.e., with an increase in temperature) causing a continuous temperature rise with heat input, a polymer composition comprising a PCM can sustain a smaller temperature rise for a given heat input.

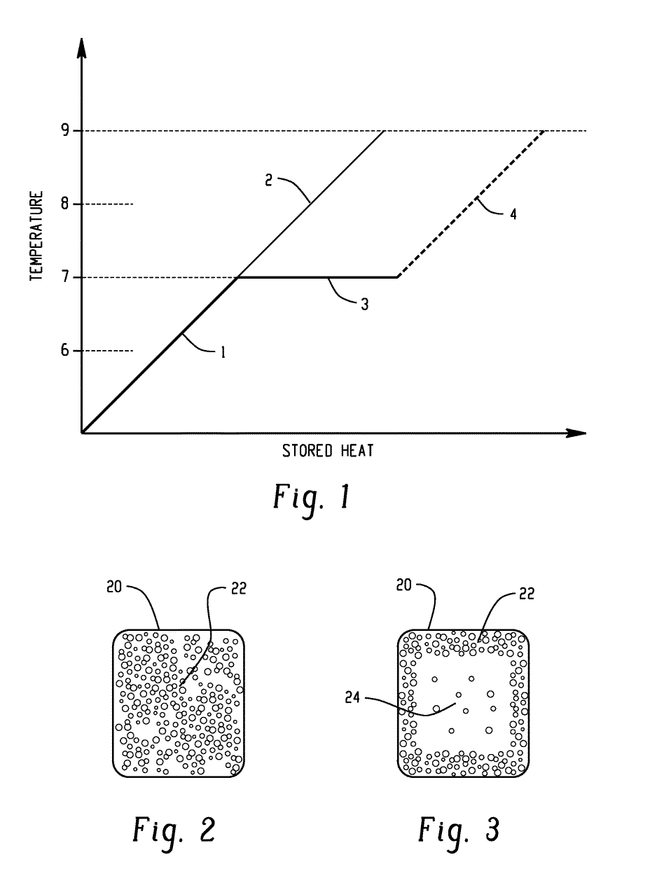

For example, FIG. 1 illustrates temperature trajectories of a polymer composition with a PCM (segments 1, 3, and 4) and a polymer composition without a PCM (segments 1 and 2). Stored heat is illustrated along the x-axis, with increasing polymer composition temperature illustrated on the y-axis, where the temperature increases above the continuous use temperature 6 of the polymer composition after formation to the elevated manufacturing temperature 9, that can be, for example, a paint-bake temperature. It is noted that as used herein, the continuous use temperature can refer to a single temperature or to a temperature range the article experiences during its lifetime. Two temperature trajectories are illustrated in which one refers to a segment of a temperature trajectory of a polymer composition comprising a PCM and a polymer composition not comprising a PCM until the phase change temperature 7 of the PCM is reached. For a polymer composition that comprises a PCM, once the phase change temperature 7 of the PCM is reached, and as heat storage increases further, the temperature initially follows a plateau 3, where the heat is stored as latent heat. This is in contrast to a polymer composition that does not comprise a PCM where the temperature trajectory 1 increases continuously on another trajectory segment 2 until the polymer composition temperature is equal to the elevated manufacturing temperature 9. FIG. 1 therefore clearly illustrates that a polymer composition comprising a PCM can prevent the polymer composition from achieving a temperature that is greater than the HDT 8 of the polymer composition as compared to a polymer composition not comprising a PCM which would reach an elevated manufacturing temperature 9 under the same manufacturing conditions. One skilled in the art readily understands that long exposure times to the elevated manufacturing temperature 9 should be avoided as the amount of latent heat storage is limited. Accordingly, after exhaustion of the available latent heat storage capacity, the polymer composition comprising the PCM will resume sensible heat storage, indicated by trajectory segment 4 in FIG. 1, where the polymer composition will reach the elevated manufacturing temperature 9.

As can be seen in FIG. 1, a polymer composition comprising a PCM can also release energy at the phase change temperature without a substantial decrease in temperature as compared to a polymer composition without a PCM. The PCM can be selected so that its phase change temperature falls within the temperature range of interest experienced by the polymer composition in the absence of a PCM Likewise, the PCM can be selected so that its phase change temperature is less than the HDT of the polymer composition. Based on FIG. 1, the average temperature of a polymer composition during the manufacturing process can be less with the inclusion of a PCM as compared to the average temperature of a polymer composition during the same manufacturing process without the inclusion of a PCM, since plateau 3 in FIG. 1 for the polymer composition comprising PCM will contribute to a lower average temperature rise as compared to a polymer composition without the PCM incorporated.

The PCM can be mixed with the polymer composition and/or can be present in a PCM layer located near a surface of the polymer composition. When mixed with the polymer composition, the PCM can be located uniformly throughout the polymer composition or can be primarily located in a region proximal to an outer surface of the polymer composition. When the PCM is located in a PCM layer, the PCM can be uniformly dispersed throughout the PCM layer or can be present in a gradient concentration from one surface of the PCM layer to a second surface. When the PCM is located in a PCM layer on at least a portion of a surface of the polymer composition, an interlayer can be present between the PCM layer and the polymer composition. The interlayer can be, for example, an insulating layer such as an air gap located between the PCM layer and the polymer composition.

FIG. 2 illustrates a polymer composition with PCM 22 that is dispersed throughout the polymer composition. PCM 22 can be uniformly dispersed throughout the polymer composition or can be non-uniformly dispersed throughout the polymer composition. Likewise, the polymer composition can comprise regions of high PCM concentration and regions of lower PCM concentration, where the regions of lower PCM concentration can comprise less or equal to half the concentration of the high PCM region, for example, the regions of lower PCM concentration can be free of the PCM. The PCM can be localized near an outer surface of the polymer composition. FIG. 3 illustrates a polymer composition that comprises a higher concentration of PCM 22 in a region that is proximal to outer surface 20 of the polymer composition such that there is reduced PCM concentration region 24 in the center. Here, the PCM can be concentrated near the surface such that as heat diffuses into the polymer composition from the outside, the PCM near the surface could potentially absorb sufficient heat for the duration of the elevated manufacturing temperature to keep the average temperature of the polymer composition below the HDT of the polymer composition. FIG. 3 further demonstrates that localizing the PCM near the surface can provide a reduced loading of the PCM compared to FIG. 2. It is noted that while FIG. 3 illustrates PCM 22 as being localized to the entire outer surface 20, PCM 22 can likewise be concentrated, for example, proximal to only a portion of outer surface 20 of the polymer composition. This selective location could be beneficial in instances where, for example, only one side of the polymer composition is exposed to the elevated manufacturing temperature, such as in the case of joining.

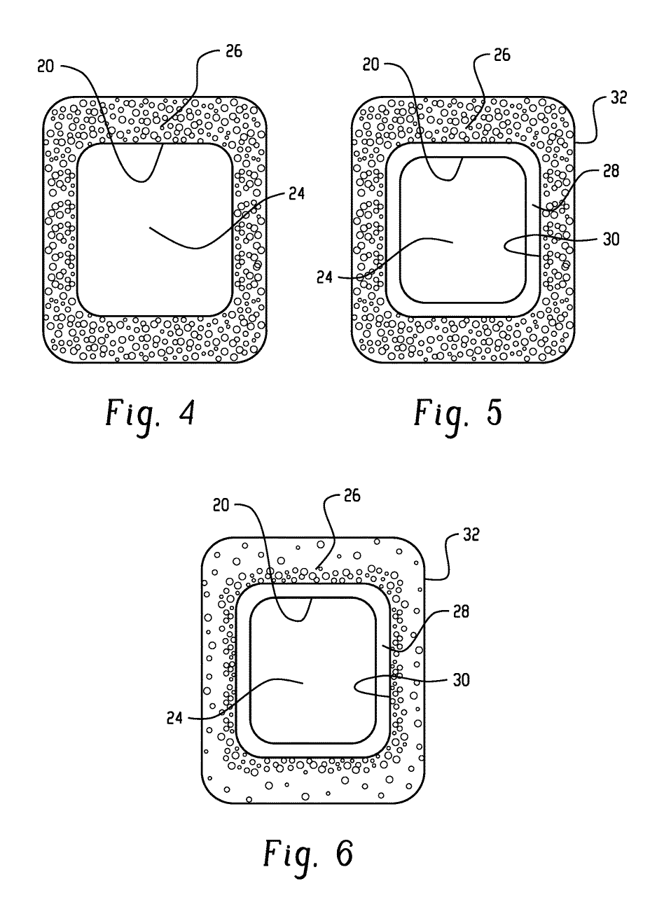

Instead of, or in addition to being dispersed in the polymer composition, the PCM can be located in a PCM layer located near at least a portion of a surface of the polymer composition. For example, the PCM layer can surround the polymer composition. As illustrated in FIGS. 4-6, the PCM can be located in PCM layer 26, such that PCM layer 26 surrounds reduced PCM region 24 that can be a polymer composition region that is free of a PCM. PCM layer 26 can be in direct physical contact with reduced PCM region 24 as illustrated in FIG. 4. FIG. 4 also illustrates that the polymer composition can be free of the PCM. Here, the polymer composition can serve essentially a mechanical function while the PCM layer 26 can localize the PCM near the surface of the polymer composition and serve essentially a thermal function.

As the PCM layer can remain on the polymer composition after manufacturing, the PCM layer and the polymer composition can be securely mechanically coupled. To enable painting of the outer surface of the PCM layer the phase change temperature of the PCM in the PCM layer can be selected to be close to the paint-bake temperature so as not to inhibit paint-bake at the outer surface. In this scenario, considering FIG. 1, the ranking of the phase change temperature of the PCM and the HDT of the polymer composition can be reversed. Additionally, in this scenario, it may be beneficial to omit a thermal conductivity enhancing additive in order to promote the divergence of temperatures between the outer and inner surfaces of the PCM layer, so that the outer surface can be hot enough to support paint-bake and the inner surface can be cool enough to usefully limit heat load on the polymer composition.

FIGS. 5 and 6 illustrate that interlayer 28 can be located between PCM layer 26 and reduced PCM region 24. Interlayer 28 can promote a larger temperature divergence between reduced PCM region 24 and outer surface 32 of PCM layer 26 as compared to the scenario where interlayer 28 is not present. The increased temperature divergence can allow the outer surface of PCM layer 26 to attain the manufacturing temperature while further helping to maintain temperature of the polymer composition to a temperature below, for example, its HDT.

Interlayer 28 can be a material layer or it can merely signify that the polymer composition and the PCM layer are spaced apart, for example, by an air gap. Accordingly, the polymer composition and PCM layer 26 can be arranged such that PCM layer 26 can be removed from the polymer composition after the manufacturing process is completed. Therefore, the extraneous weight of PCM layer 26 can be eliminated from the final article. For example, PCM layer 26 can be recovered intact and reused for the manufacture of another article. It is noted that, as used here, removing (and removable) refers to the ability to remove the PCM layer without damage to the polymer composition. When applied to automobile manufacturing, a removable PCM layer can be particularly advantageous for a low-HDT floor or underbody that is, for example, made from fiber reinforced polypropylene, which has a relatively large surface area. A removable PCM layer could enable such a floor or underbody to be incorporated into the body-in-white before the paint-bake cycle, potentially more securely and with fewer steps.

FIG. 6 further illustrates that PCM layer 26 can comprise a concentration gradient of the PCM, where a higher concentration of the PCM can occur near inner surface 30 of PCM layer 26 as such a localization can also support a temperature divergence between reduced PCM region 24 and outer surface 32 of PCM layer 26. The PCM layer can be free of a thermal conductivity enhancing additive. When the PCM is located near the inner surface, the phase change temperature of the PCM can be below the manufacturing temperature and can be below the HDT of the polymer composition, as in FIG. 1. In this scenario, the PCM layer can sustain, during the manufacturing, the elevated manufacturing temperature at its outer surface 32 and the phase change temperature of the PCM at its inner surface 30. Likewise, the PCM layer can be configured as two or more sub-layers, for example, as an outer sub-layer without PCM, surrounding an inner sub-layer with PCM, which in turn surrounds the reduced PCM region. The outer surface of the outer sub-layer can attain the manufacturing temperature.

Where a gradient PCM layer is employed, greater than or equal to 60 wt % of the PCM can be located closer to one surface. For example, greater than or equal to 60 wt % of the PCM can be located closer to inner surface 30 than to outer surface 32.

It is noted that while FIGS. 4-6 illustrate that the surrounding PCM layer 26 can be located around the entire polymer composition, PCM layer 26 can likewise be located, for example, proximal to only a portion of outer surface 20 of the polymer composition. This selective location could be beneficial in instances where, for example, only one side of the polymer composition is exposed to the elevated manufacturing temperature, such as in the case of joining.

Embodiments are also envisioned wherein any of the aforementioned embodiments are combined in any manner using either the same or a different PCM.

A thermal conductivity modifying additive can be dispersed in any of the above described locations for the PCM in addition to the PCM.

The polymer composition can be designed for the specific transient heat load of the manufacturing process. Specific design parameters regarding the PCM can include the phase change temperature, an optional encapsulation material, particle size, processing compatibility, stability, and cost. It is noted that cycle life of the PCM, an important consideration for applications where the PCM is cycled between its phases repeatedly, is not important for the current application where the PCM is only exposed to the high manufacturing temperatures during the manufacturing of the article. In applications such as automobile manufacturing, the PCM may undergo only a single phase change cycle (e.g., solid to liquid to solid) during the paint-bake cycle. In this case, no phase change cycles would occur in the finished vehicle since the phase change temperature of the PCM is generally at least as high as the continuous use temperature, as illustrated in FIG. 1, and the continuous use temperature is generally at least as high as the maximum temperature the vehicle might experience in service.

System design parameters include loading and distribution of PCM and of any optional thermal conductivity modifying additive in the host material. These parameters would reflect duration of and temperature during the manufacturing process, dimensions of the polymer composition, and thermal contact of the polymer composition with other components in the article. When the PCM and optional thermal conductivity modifying additive are localized either within the polymer composition as illustrated in FIG. 3 or in a surrounding layer as illustrated in FIGS. 4-6, the thickness of the high concentration region or of the layer can be considered as a design parameter.

The polymer composition can have a filled, channeled structure. The channels can be arranged in an array, for example, of circular channels, oval channels, square channels, rectangular channels, triangular channels, diamond channels, pentagonal channels, hexagonal channels, heptagonal channels, octagonal channels, irregular channels, as well as combinations comprising one or more of the foregoing. A long axis of the channels can be oriented at an angle of 45 to 135 degrees, specifically, 60 to 120 degrees, more specifically, 80 to 100 degrees, for example, 90 degrees with respect to a surface of the second material. The density of channels (number of channels per unit area) can be 1 to 20 channels per 100 millimeter squared (mm²), specifically, 1 to 10 channels per 100 mm², and more specifically 1 to 5 channels per 100 mm². The thickness of the channel walls can be 0.5 to 10 millimeter (mm), specifically, 2 to 5 mm, and more specifically, 2.5 to 4 mm.

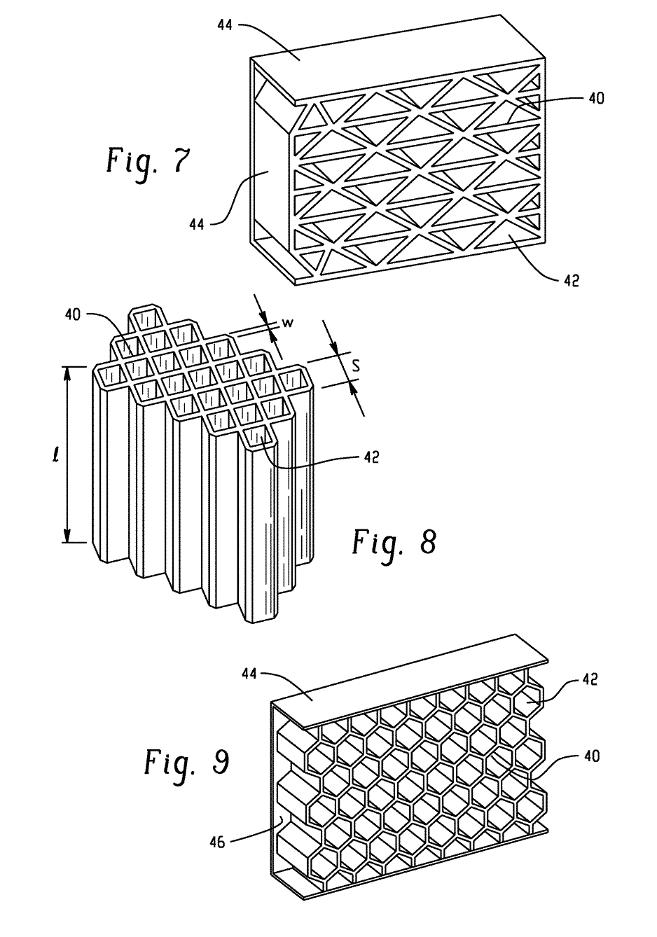

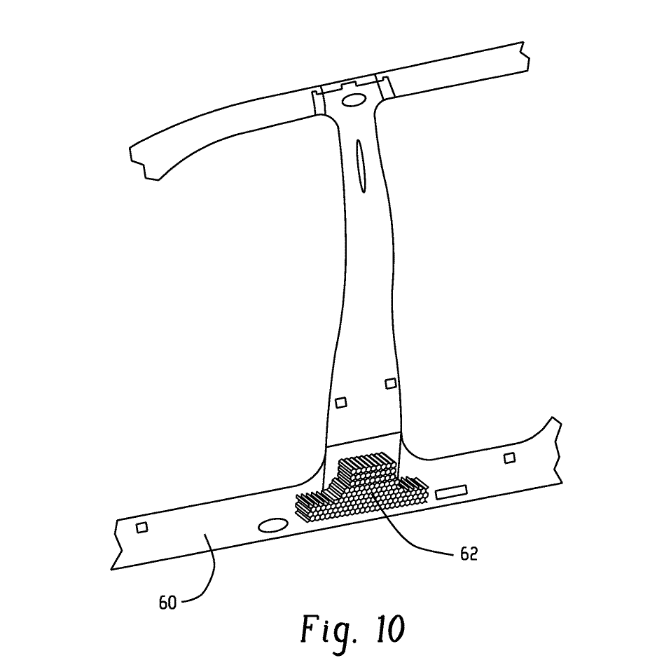

FIGS. 7-9 illustrate examples of a polymer composition structure comprising a plurality of channels 42, where FIG. 7 is an illustration of a triangular array, FIG. 8 is an illustration of a square array, and FIG. 9 is an illustration of a hexagonal array. The polymer composition structure comprises walls 40 that make up the walls of the channels 42. The polymer composition structure can comprise one or both of outer wall 44 that defines an outer edge of the polymer composition structure and a base wall 46 that covers the openings of the channels 42 on one side of the polymer composition structure. Base wall 46 can be in contact with the second material. FIG. 10 illustrates that polymer composition structure 62 can be located on and in contact with second material 60.

The channels are filled with a fill material. The fill material can have a thermal conductivity of less than or equal to 0.5 Watts per meter Kelvin (W/mK), specifically, less than or equal to 0.05 to 0.001 W/mK at a pressure of 1 atmosphere (atm) as measured at 23° C. The channels are filled with a fill material. The fill material can have a thermal conductivity of less than or equal to 0.08 W/mK, specifically, less than or equal to 0.08 to 0.001 W/mK at a pressure of 1 atm as measured at 23° C. The fill material can comprise an aerogel. The aerogel can comprise a silica aerogel, an alumina aerogel, a chromia aerogel, a zirconia aerogel, a vanadia aerogel, a neodynium oxide aerogel, a samarium oxide aerogel, a holmium oxide aerogel, an erbium oxide aerogel, a tin dioxide aerogel, a carbon aerogel, or a combination comprising one or more of the foregoing. The aerogel can comprise a silica aerogel, an alumina aerogel, a carbon aerogel, or a combination comprising one or more of the foregoing. Aerogels are porous, light-weight materials that can comprise greater than or equal to 90 vol %, specifically, greater than or equal to 95 vol %, more specifically, 97 to 99.5 vol % air. Due to the high volume percent of air, aerogels are good thermal insulators.

The aerogel can be prepared by removing a liquid component from a precursor gel by drying. The drying can occur in a vacuum or in an inert atmosphere, for example, comprising argon or nitrogen. The drying can occur at a temperature of 300 to 1800° C. The drying can take 1 to 20 hours. The aerogel can be prepared using resorcinol-formaldehyde (RF) chemistry in order to form an aerogel network of polymeric colloids. The pore structure of RF monoliths can be influenced by ultrasonically disrupting RF oligomers. Post processing of the aerogel can be performed to make the aerogel hydrophobic.

The aerogel can have interconnected pores with an average diameter of 2 to 2,000 nm. The aerogel can have one or both of mesopores, for example, with an average diameter of 2 to 50 nm, specifically, 2 to 25 nm and macropores, for example, with an average diameter of greater than 50 nm, specifically, 50 to 800 nm. The pores can be defined by walls with a thickness of 5 to 50 nm, specifically, 15 to 25 nm, for example, 20 nm.

The polymer composition structure can be made by injection molding or extruding the structure in the direction of the channels. Conversely, the polymer composition structure can be made by bonding multiple tubes together. The fill material can be formed directly in the channels. A fixing measure can be present and can enhance the fit of the fill material in the channel. For example, the fixing measure could be a wall opening such that during forming of two neighboring fill materials, the fill materials in the neighboring channels are connected through the wall opening. Instead of forming the fill material in the channels, fill material inserts can be prepared and can be inserted into the channels prior to manufacturing. In this case, one or more of the fill material inserts can form a tight fit (e.g. a friction fit) with the channel such that it does not fall out when the channels are faced downward and/or one or more of the fill material inserts can form a loose fit with the channel such that they would fall out due to gravity when the channels are faced downward in the absence of a mechanical fixing measure (such as a notch on the channel wall, a screw, a crimped metal wall) or a chemical fixing measures (such as an adhesive). The fill material can optionally be removed from the channels after manufacturing or can remain in the channels during use of the article, for example, for the lifetime of the article.

A PCM can be located in one or both of the polymer composition structure and the fill material. If the melting temperature of an organic polymer composition in the fill material is less than the ambient temperature, for example, of the paint bake cycle, then it can serve as a PCM, for example, a shape-stabilized PCM or an encapsulated PCM.

The polymer composition can comprise, but is not limited to, oligomers, polymers, ionomers, dendrimers, copolymers such as graft copolymers, block copolymers (e.g., star block copolymers, random copolymers, etc.) and combinations comprising at least one of the foregoing. The polymer composition can comprise a thermoset, a thermoplastic, or a combination comprising one or both of the foregoing. Examples of such polymer compositions include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends, high impact polystyrene), polyimides (e.g., polyetherimides), acrylonitrile-butadiene-styrene (ABS), acrylonitrile-styrene-acrylonitrile (ASA), acrylonitrile-(ethylene-polypropylene diamine modified)-styrene (AES), polyvinyl chloride PVC, polyalkylmethacrylates (e.g., polymethylmethacrylates (PMMA)), polyesters (e.g., copolyesters, polythioesters, polyethylene terephthalate, polybutylene terephthalate), polyolefins (e.g., polypropylenes (PP) and polyethylenes, high density polyethylenes (HDPE), low density polyethylenes (LDPE), linear low density polyethylenes (LLDPE)), polyamides (e.g., polyamideimides), polyarylates, polysulfones (e.g., polyarylsulfones, polysulfonamides), polyphenylene sulfides, polytetrafluoroethylenes, polyethers (e.g., polyether ketones (PEK), polyether ether ketones (PEEK), polyethersulfones (PES)), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazzanes, polysiloxanes, fluoropolymers (e.g., polyvinyl fluoride (PVF), polyvinylidene fluoride (PVDF), fluorinated ethylene-propylene (FEP), polyethylenetetrafluoroethylene (ETFE)) and combinations comprising at least one of the foregoing.

More particularly, the polymer compositions can include, but are not limited to, polycarbonate resins (e.g., LEXAN™ resins, commercially available from SABIC Innovative Plastics), polypropylene resins (such as STAMAX™, commercially available from SABIC Innovative Plastics), polyphenylene ether-polystyrene resins (e.g., NORYL™ resins, commercially available from SABIC Innovative Plastics), polyetherimide resins (e.g., ULTEM™ resins, commercially available from SABIC Innovative Plastics), polybutylene terephthalate-polycarbonate resins (e.g., XENOY™ resins, commercially available from SABIC Innovative Plastics), copolyestercarbonate resins (e.g., LEXAN™ SLX resins, commercially available from SABIC Innovative Plastics) polycarbonate/acrylonitrile butadiene styrene resin (e.g., CYCOLOY™, commercially available from SABIC Innovative Plastics), poly(phenylene sulfur) resins (such as KONDUIT™, commercially available from SABIC Innovative Plastics) and combinations comprising at least one of the foregoing resins. Even more particularly, the polymer compositions can include, but are not limited to, homopolymers and copolymers of a polycarbonate, a polyester, a polyacrylate, a polyamide, a polyetherimide, a polyphenylene ether, or a combination comprising at least one of the foregoing resins. The polycarbonate can comprise copolymers of polycarbonate (e.g., polycarbonate-polysiloxane, such as polycarbonate-polysiloxane block copolymer), linear polycarbonate, branched polycarbonate, end-capped polycarbonate (e.g., nitrile end-capped polycarbonate), and combinations comprising at least one of the foregoing, for example, a combination of branched and linear polycarbonate.

The polymer composition can have a specific heat of 0.1 to 3.5 kiloJoules per kilogram Kelvin (kJ/kgK), specifically, 0.5 to 2.5 kJ/kgK, more specifically, 1 to 2.5 kJ/kgK. The polymer composition can have a mass density of 800 to 2,200 kilograms per meter cubed (kg/m³), specifically, 900 to 1,300 kg/m³. The polymer composition can have a thermal conductivity of 0.1 to 0.5 watts per meter Kelvin (W/mK). The polymer composition can have a thermal diffusivity of less than or equal to 3×10⁵ meters per second squared (m/s²), specifically, 1×10⁻⁷ to 1×10⁻⁸ m/s². All properties unless stated otherwise can be measured at a temperature of 23° C.

The polymer composition can include various additives ordinarily incorporated into polymer compositions of this type, with the proviso that the additive(s) are selected so as to not significantly adversely affect the desired properties of the polymer composition, for example, transparency and/or impact properties. Such additives can be mixed at a suitable time during the mixing of the components for forming articles made from the polymer compositions. Exemplary additives include impact modifiers, fillers, reinforcing agents, antioxidants, heat stabilizers, light stabilizers, ultraviolet (UV) light stabilizers (e.g., UV absorbing), plasticizers, lubricants, mold release agents, antistatic agents, colorants (such as carbon black and organic dyes), surface effect additives, infrared radiation stabilizers (e.g., infrared absorbing), flame retardants, thermal conductivity enhancers, thermal conductivity reducers, and anti-drip agents. A combination of additives can be used, for example, a combination of a heat stabilizer, mold release agent, and ultraviolet light stabilizer. In general, the additives are used in the amounts generally known to be effective. The total amount of additives (other than any impact modifier, filler, or reinforcing agents) is generally 0.001 weight % to 30 weight %, based on the total weight of the composition. Optionally, fibers (e.g., carbon, ceramic, or metal) can be incorporated into the polymer composition to enhance or reduce thermal conductivity, subject to compatibility with optical and/or aesthetic requirements and/or impact properties.

The polymer composition can comprise a filler. The filler can comprise fibers, particles, flakes, as well as combinations comprising at least one of the foregoing. For example, the polymer composition can comprise a glass fiber. Glass fibers can be formed from a fiberizable glass composition such as “E-glass,” “A-glass,” “C-glass,” “D-glass,” “R-glass,” “S-glass,” as well as E-glass derivatives that are fluorine-free and/or boron-free. The glass fibers can have an average diameter of 4.0 to 35.0 micrometers, specifically, 9.0 to 30.0 micrometers. In preparing the glass fibers, a number of filaments can be formed simultaneously, optionally treated with the coating agent, and bundled into a strand.

Exemplary PCMs include, but are not limited to, zeolite powder, polytriphenylphosphate, crystalline paraffin wax, polyethyleneglycol, fatty acid, naphthalene, calcium bichloride, polyepsilon caprolactone, polyethylene oxide, polyisobutylene, polycyclopentene, polycyclooctene, polycyclododecene, polyisoprene, polyoxytriethylene, polyoxytetramethylene, polyoxyoctamethylene, polyoxypropylene, polybutyrolactone, polyvalerolactone, polyethyleneadipate, polyethylene suberate, polydecamethylazelate, and combinations comprising at least one of the foregoing.

The PCM can be implemented in various forms, including, but not limited to discretely encapsulated PCM particles with diameters of a few micrometers or as a shape-stabilized PCM where the shape of a PCM in its solid or liquid phase is maintained by a supporting structure such as a polymeric matrix. The encapsulant can, for example, comprise a microsphere (e.g., with glass or polymer composition as the encapsulant). In such a case, the PCM can be discretely encapsulated by the microsphere.

The PCM can have a latent heat of 100 to 600 kiloJoules per kilogram (kJ/kg), specifically, 200 to 400 kJ/kg. The PCM can have a melting temperature that is less than the manufacturing temperature. The PCM can have a melting temperature of less than or equal to 200° C., specifically, less than or equal to 150° C., more specifically, 30 to 150° C. If present in the polymer composition, the PCM can be present in an amount of 1 to 50 wt %, specifically, 10 to 40 wt %, more specifically, 15 to 25 wt % based on the total weight of the polymer composition and the PCM. If present in the fill material, the PCM can be present in an amount of 1 to 50 wt %, specifically, 10 to 40 wt %, more specifically, 15 to 25 wt % based on the total weight of the fill material and the PCM.

The PCM can be incorporated into the polymer composition in various locations, including, but not limited to, incorporation in a first shot and/or a second shot for two-shot injection molded components. For example, PCM incorporated into the first and second shots can include PCMs with different respective forms (e.g., discretely encapsulated PCM particles or shape-stabilized PCM particles), and/or sizes, and/or materials, and/or loadings. When incorporating a PCM into the second shot in a two-shot injection molding process, where the second shot can generally be opaque or relatively dark, the loading, and/or size, and/or material, and/or form of the PCM in the second shot would not be limited by specifications for optical transmission and/or haze.

A thermal conductivity modifying additive (such as a thermal conductivity reducing additive or a thermal conductivity enhancing additive) can be added to modify the thermal conductivity of the material in which the additive is embedded. A thermal conductivity reducing additive can be added to reduce the thermal conductivity of the material in which the additive is embedded. For example, if the thermal conductivity reducing additive is embedded in the polymer composition, the thermal conductivity reducing additive has a lower thermal conductivity than the polymer composition, is compatible with the polymer composition, and can function to retard diffusion of heat from the outer surface of the polymer composition to its interior. An example of a thermal conductivity reducing additive is void space. Likewise, a thermal conductivity enhancing additive can be added to enhance the thermal conductivity of the material in which the thermal conductivity enhancing additive is embedded.

The thermal conductivity modifying additive can comprise metals, metal oxides, ceramics, carbon (such as graphite), carbon phases, silica, metal silicon, or combinations comprising at least one of the foregoing. Examples of metals include but are not limited to aluminum, magnesium, tungsten, copper, nickel, lead, gold, silver, alloys thereof such as steel, and combinations comprising at least one of the foregoing. Examples of metal oxides include but are not limited to cupric oxide, gold, silver and palladium oxides, and combinations comprising at least one of the foregoing. Other possible materials include but are not limited to aluminum nitride, beryllium oxide, boron nitride, high conductivity cermets, cuprates, and silicides, and combinations thereof. Examples of carbon and carbon phases include but are not limited to carbon nano-tubes, graphite, graphene sheets, related derivatives, and combinations thereof. The thermal conductivity modifying additive components can be coated e.g., aluminum coated copper. The thermal conductivity modifying additive can be utilized in forms such as those of a powder (e.g., a fine powder), fibers, nano-tubes, fins, honeycomb, mesh, or combinations comprising at least one of the foregoing. Fibers can be in various forms such as wool, brush, etc.

The thermal conductivity modifying additive can have a thermal conductivity of greater than or equal to 1 W/mK, specifically, greater than or equal to 10 W/mK, for example, greater than or equal to 100 W/mK as measured at 23° C. The thermal conductivity modifying additive can have a thermal conductivity of 0.01 to 100 W/mK. The thermal conductivity modifying additive can have a thermal conductivity of 0.01 to 1 W/mK, specifically, 0.01 to 0.5 W/mK as measured at 23° C.

A thermal conductivity modifying additive can be incorporated into the polymer composition in the same or different manner as the PCM.

The second material can be a material that has a manufacturing temperature that is greater than, for example, the HDT of the polymer composition. The second material can comprise a metal.

The following examples are provided to illustrate the article with enhanced thermal capability. The examples are merely illustrative and are not intended to limit devices made in accordance with the disclosure to the materials, conditions, or process parameters set forth therein.

### EXAMPLES

In the examples, a simple physical model is developed to demonstrate the effect of the PCM in a welding process (Examples 1-6) and the filled structure in a paint bake cycle (Examples 7-9) on the average temperature of the polymer composition. In the model, a one-dimensional semi-infinite medium (x>0) is initially at temperature, Tᵢ, where it is noted that the medium can refer to the polymer composition or the fill material depending on the example. At time t=0, the temperature at the surface of medium (x=0) is raised to an air temperature, Tₐ. This condition is reasonable for both welding and for the paint bake cycle, where the polymer composition surface(s) reaches a threshold or target temperature within a time much less than the duration of the process tₚ. In the paint bake cycle, the polymer composition enters a cure oven where the air temperature, Tₐ, is driven by forced convection, which is intended to enhance heat transfer to exposed surfaces.

Analytical solutions for the subsequent temperature in the medium T(x>0, t>0) are available without PCM and with PCM uniformly distributed in the medium. In the latter case the PCM has a phase change (melting) temperature, Tₘ. The solutions are sufficiently accurate for present purposes for a medium of finite depth (0<x<d) at times short enough that the characteristic thermal diffusion depth satisfies δ<d. The three temperatures above satisfy Tₐ>Tₘ>Tᵢ. The second inequality means that the PCM (if present) is initially solid, i.e. is solid everywhere at t=0. The first inequality means there will be local phase change at later times.

A melt front is defined as x=Xₘ(t), which is the position of the interface between liquid (x<Xₘ) and solid (x>Xₘ) phases of the PCM. If present, the PCM has a mass fraction, Lₘ, in the medium. Density of the PCM can be different for its liquid and solid phases, but its mass fraction in the medium does not change upon melting. Thus, Lₘ is same on both sides of melt front. Density differences would be manifested as differences in volume fraction on both sides of melt front.

To highlight the effect of phase change on average temperature the specific heat, thermal conductivity, and mass density of the PCM (liquid and solid phases), if present, are made equal to the respective values for the host medium: cₚ, kₚ, and ρₚ. In this manner, the addition of PCM to the medium does not change these parameters or the thermal diffusivity, αₚ=kₚ/ρₚcₚ, and the effect of PCM on average temperature can be attributed specifically to local phase change of the PCM without the confounding effect of changes in these parameters due to the introduction of the PCM.

### Examples 1-6

### Polymer Composition with and without a PCM During Polymer Composition Welding

Examples 1-6 demonstrate the effect of properties of the PCM and the polymer composition on the average temperature of the polymer composition, where Examples 1 and 2 are free of the PCM and Examples 3-6 comprise a PCM. In the model, if PCM is absent then the temperature in the polymer composition is defined by Equation (1)

T(x,t)=Tₐ+(Tᵢ−Tₐ)erf(x/\sqrt{4αₚt}) (1)

where erf(z) is the error function. Since erf(1.83)≅0.99, and since erf(z) increases monotonically with its argument, T(x, t) differs from its initial value Tᵢ by less than 1% at x>δ(tₚ)=3.66\sqrt{αₚt}. Then Eq. 1, derived for a semi-infinite medium, is a good approximation for T(x, t) in a slab of finite thickness d, heated only at x=0, for as long as δ(tₚ)<d. The average temperature of the slab at time tₚ is defined by Equation (2)

$${T}_{ave} ( d , {t}_{p} ) = \frac{1}{d} [ {\int }_{0}^{{X}_{m} ( {t}_{p} )} {T}_{l} ( x , t ) d x + {\int }_{{X}_{m} ( {t}_{p} )}^{d} {T}_{s} ( x , t ) d x ] \qquad ( 5 )$$

where T is defined by Equation (1).

If PCM is present then the so-called Neumann method provides a solution for a semi-infinite medium. The position of the melt front is defined by

Xₘ(t)=2λ\sqrt{αₚt}

where λ is the solution to the transcendental equation

λ\sqrt{π} exp(λ²)=cₚ[(Tₐ−Tₘ)/erf(λ)−(Tₘ−Tᵢ)/erfc(λ)]/(LₘΔH_{PCM})

where exp(z) is the exponential function, erfc(z)=1−erf(z) is the complementary error function and ΔH_{PCM} is the latent heat of fusion of the PCM. The temperature in the region where PCM is melted (0<x<Xₘ) is defined by Equation (3)

Tₗ(x,t)=Tₐ−(Tₐ−Tₘ)erf(x/2\sqrt{αₚt})/erf(λ) (3)

The temperature in the region where PCM has not yet melted (x>Xₘ) is defined by Equation (4)

Tₛ(x,t)=Tᵢ+(Tₘ−Tᵢ)erf(x/2\sqrt{αₚt})/erfc(λ) (4)

Anticipating that the effect of introducing the PCM is to reduce the average temperature of a slab of finite thickness d the condition above for applicability of the solution for a semi-infinite medium also applies when PCM is present. Then since 0<λ<1,

Xₘ(tₚ)=2λ\sqrt{αₚtₚ}<2\sqrt{αₚtₚ}δ(tₚ)

So the earlier condition on slab thickness d implies that Xₘ(tₚ)<d. The average temperature of the slab then involves integration in both the liquid and solid PCM regions:

$${T}_{ave} ( d , {t}_{p} ) = \frac{1}{d} {\int }_{0}^{d} T ( x , {t}_{p} ) d x \qquad ( 2 )$$

where T₁ and Tₛ are given by Equations (3) and (4), respectively.

Table 1 summarizes Examples 1-2 (without PCM) and Examples 3-6 (with PCM).

TABLE 1

| | | | | | | |
|---|---|---|---|---|---|---|
| Example | 1 | 2 | 3 | 4 | 5 | 6 |

Process Parameters

| | | | | | | |
|---|---|---|---|---|---|---|
| Air temperature, Tₐ, (° C.) | 250 | 250 | 250 | 250 | 250 | 250 |
| Tᵢ, (° C.) | 23 | 23 | 23 | 23 | 23 | 23 |
| Welding time, tₚ, (min) | 0.5 | 0.5 | 0.5 | 0.5 | 0.5 | 0.25 |

Polymer parameters

| | | | | | | |
|---|---|---|---|---|---|---|
| Slab thickness, d, (mm) | 7.5 | 7.5 | 7.5 | 7.5 | 7.5 | 7.5 |
| Specific heat, cₚ, (kJ/kgK) | 1.8 | 1.8 | 1.8 | 1.8 | 1.8 | 1.8 |
| Mass density, ρₚ, (kg/m³) | 900 | 900 | 900 | 900 | 900 | 900 |
| Thermal conductivity, kₚ, (W/mK) | 0.20 | 0.22 | 0.20 | 0.22 | 0.20 | 0.40 |

PCM Parameters

| | | | | | | |
|---|---|---|---|---|---|---|
| Mass fraction, Lₘ | — | — | 0.2 | 0.2 | 0.2 | 0.2 |
| Latent heat, ΔH_{PCM}, (kJ/kg) | — | — | 350 | 350 | 350 | 350 |
| Melting temperature, Tₘ, (° C.) | — | — | 55 | 55 | 140 | 55 |

Results

| | | | | | | |
|---|---|---|---|---|---|---|
| Thermal diffusion depth at time tₚ, | 7.0 | 7.4 | — | — | — | — |
| δ(tₚ), (mm) | | | | | | |
| Tₐᵥₑ(d, tₚ), (° C.) | 88.6 | 91.7 | 79.8 | 82.6 | 85.8 | 79.8 |
| Solution to transcendental equation, λ | — | — | 0.842 | 0.842 | 0.420 | 0.842 |
| Melt front position at time tₚ, | — | — | 3.2 | 3.4 | 1.6 | 3.2 |
| Xₘ(tₚ), (mm) | | | | | | |

Table 1 shows that the condition δ(tₚ)<d for applicability of the solutions to a slab of finite thickness is met. The beneficial effect of PCM on average temperature of the polymer composition is indicated by comparison of Examples 1 and 3 and Examples 2 and 4. Example 3 as compared to Example 1 shows a reduction in Tₐᵥₑ of almost 10° C. from 88.6° C. to only 79.8° C. by the inclusion of PCM. Example 4 as compared to Example 2 shows a reduction in Tₐᵥₑ of almost 10° C. from 91.7° C. to only 82.6° C. by the inclusion of PCM. Example 5 as compared to Example 3 shows that increasing the melting temperature of the PCM from 55° C. to 140° C. resulted in an increase in Tₐᵥₑ of 6° C. from 79.8° C. to 85.8° C.

The presence of PCM reduces the average temperature of the polymer composition compared with the same polymer composition without PCM. This reduction can enable combinations of materials and welding processes that are currently precluded because the polymer composition attains an unacceptably high average temperature in the absence of PCM.

It is noted that in Examples 3-5, the specific heat, thermal conductivity, and mass density of the PCM (liquid and solid phases) were made equal to the respective values for the polymer composition in order to isolate the effect of phase change on average temperature. The beneficial effect of the PCM on average temperature can be further enhanced by selecting the PCM with respect to its specific heats, thermal conductivities, and densities (liquid and solid phases) that are different from those of the polymer composition.

As compared to the heat absorb-release plastic composition of U.S. Pat. No. 6,927,249, it was surprisingly discovered that a lower polymer composition thermal conductivity was beneficial as it ultimately results in a slower diffusion of heat into the polymer composition, resulting in a reduction in the rate of the average temperature increase with time. Conversely, U.S. Pat. No. 6,927,249 discloses a higher thermal conductivity of at least 0.4 W/mK. Example 6 shows that when this value of 0.4 W/mK is used in the model above, with other parameters in Table 1, the value of Tₐᵥₑ(d,tₚ) in Example 3 is attained in half the time, i.e. for tₚ=0.25 minutes, after which the polymer composition average temperature continues to rise so that it exceeds the value in Example 3 at tₚ=0.5 minutes.

A further difference from U.S. Pat. No. 6,927,249, consistent with the difference above regarding thermal conductivity of the polymer composition, relates to the dominant resistance to heat flow. In the present application, the dominant thermal resistance is preferably heat conduction within the polymer composition; the welding and the paint bake cycle support this by raising temperature of the polymer composition surface(s) to its target value early in the respective process. Herein, it was surprisingly found that an article comprising a polymer composition could withstand a high manufacturing temperature. This surprising feature could not have been anticipated from the disclosures of U.S. Pat. No. 6,927,249.

As compared to the fiber-reinforced thermoplastic composition of U.S. Patent Application 2010/0313605, U.S. Patent Application 2010/0313605 describes the forming of a thermoplastic polymer composition with an impregnating agent with a melting point at least 20° C. below the melting point of the thermoplastic matrix, for example, 160° C. for polypropylene. U.S. Patent Application 2010/0313605 discloses that their application temperature is chosen such that the desired viscosity range is obtained. In other words, U.S. Patent Application 2010/0313605 is promoting the case where a uniform temperature is achieved and their impregnating agent has liquefied throughout the entire polymer composition.

The present application is concerned with maintaining an average polymer composition temperature below a threshold during processing at high temperature and/or maintaining greater than or equal to 50% of the polymer composition volume below at least one of the heat deflection temperature, the melting temperature, the glass transition temperature, and the degradation temperature. This entails selection of parameters that inhibit the diffusion of heat that would attain uniform temperature across the first portion (and hence the polymer composition). In fact, if the polymer composition attained a uniform temperature during processing, that temperature would be Tₐ which, if it exceeds a temperature that degrades the polymer composition or deforms the first portion, then it creates the problem solved herein.

In this case, maintaining the average temperature of the polymer composition below these characteristic temperatures requires a non-uniform temperature profile. For example, in the present application, a phase change front for the PCM can reach a penetration depth of less than or equal to 70% from a surface of the first portion, specifically, less than or equal to 40%, more specifically, less than or equal to 30% of the distance perpendicular to the applied temperature. If the applied temperature is on two opposing sides of the first portion (comprising the polymer composition), then the phase change front for the PCM can reach a penetration depth from the respective surfaces of less than or equal to 35%, specifically, less than or equal to 20%, more specifically, less than or equal to 10% of the distance perpendicular to the applied temperature. For example, the phase change front for the PCM can reach a penetration depth of less than or equal to 5 mm, specifically, less than or equal to 3 mm, more specifically, less than or equal to 2 mm from a surface of the applied temperature, e.g., if the process is a joining process (such as welding and/or soldering).

### Example 7-9

### Polymer Composition with and without a Filled, Channeled Structure During a Paint Bake Cycle

Examples 7-9 demonstrate the effect of a filled polymer composition structure on the average temperature of the polymer composition, where Example 7 is a model of an unfilled square channel array and Examples 8 and 9 are models of a filled square array, filled with a silica aerogel and a polyurethane (PU) foam, respectively. Because the wall thickness of the array is already exceeded by a typical value of the thermal penetration distance δ(tₚ) at tₚ=0.5 minutes (Table 1, Example 1), in an unfilled channel, the wall temperature is equilibrated at the ambient temperature, Tₐ, (200° C.) during most of the paint bake cycle. Many polymer compositions are therefore excluded during such a process due to at least to one of the heat deflection temperature, melting temperature and degradation temperature being less than Tₐ even though such polymer compositions may be more attractive in service, for example, due to better mechanical performance or lower weight.

In the model, the thickness, w, of the polymer composition walls of the square honeycomb array are 3.4 mm, the width, S, of the square channel is 10 mm, and the length, l, of the channels is 100 mm, where the thickness, width, and length are illustrated in the square array in FIG. 8. A thermal diffusion length L=\sqrt{αtₚ} characterizes penetration of the effect of air at temperature, Tₐ, at the boundary of a medium with a thermal diffusivity, α. In Example 7, the channels of the honeycomb are filled with air, which may be quiescent, for example, if the channels are closed at one end. Due to the relatively high thermal diffusivity in air, the thermal diffusion length , Lᵣ, of 240 mm exceeds the length, l, of 100 mm of the channels sufficiently that the interior walls are exposed to air at temperature, Tₐ, over their entire length for more than 75% of the process period, tₚ. Because the thermal diffusion length, L_{w}, characteristic of the walls exceeds the wall thickness, w, within about 3 minutes, the wall temperature is equilibrated at Tₐ during most of the paint bake cycle.

The channels of Example 8 are filled with an aerogel or foam. The aerogel or foam serves several functions: it excludes from the channels the air at temperature, Tₐ, it suppresses convective heat transfer within the channels, and it fills most of the channel volume with a medium of lower thermal diffusivity than air and of lower mass density than the walls of the honeycomb. In Example 8, an aerogel in the channels substantially displaces the air and inhibits heat transfer to the walls from the hot air directly to the walls along their length. The thermal diffusivity, of the aerogel is such that the thermal diffusion length Lₐ, in the aerogel at tₚ=30 minutes is only 13 mm compared with the length, l, of 100 mm of the channels. In this case, negligible heat is transferred from the aerogel-filled channels to the interior walls over most of their length. The aerogel parameters in this example were defined based on the silica aerogel of A C Pierre and G M Pajonk, Chemistry of aerogels and their applications, Chem. Rev. 102 (2002) 4243-4265.

Due to the presence of aerogel in the channels, heating of the interior walls is due mainly to conduction within the walls themselves, along their length, of heat transferred to the narrow edges of the walls at one or both ends of the channels where those edges are exposed directly to air at temperature, Tₐ. The thermal diffusion length L_{w}=\sqrt{α_{w}tₚ} in the wall material (for example, in the form of a block) at tₚ=30 minutes is small compared with the length, l, of channels, so walls of thickness, w, heated at one or both ends of channels are not significantly heated over most of their length during the process by conduction within the walls along their length.

Because both Lₐ and L_{w} are small compared with l while Lᵣ exceeds l the average temperature of the interior walls of the honeycomb remains well below Tₐ for the duration of the paint bake cycle when the aerogel is present in the channels, whereas it equilibrates at Tₐ when air fills the channels as in the prior art. This result does not depend on thermal contact between the aerogel and the interior walls, and does not depend on a tight fit of the aerogel in the channels.

TABLE 2

| Example | 7 | 8 | 9 |
|---|---|---|---|
| Air temperature, T_{α}, (° C.) | 200 | 200 | 200 |
| Tᵢ, (° C.) | 23 | 23 | 23 |
| Welding time, tₚ, (min) | 30 | 30 | 30 |

Channel Parameters

| | | | |
|---|---|---|---|
| Channel fill | Air | Aerogel | PU |
| Specific heat, (kJ/kgK) | 1.013 | 1 | 3.2 |
| Density, (kg/m³) | 0.963 | 150 | 374 |
| Thermal conductivity, (W/mK) | 0.031 | 0.015 | 0.1 |
| Thermal diffusivity, (m²/s) | 3.2E−05 | 1.00E−07 | 8.6E−08 |
| Thermal diffusion length along the | 240 | 13 | 12 |
| length of the channel, (mm) | | | |
| Weight addition from air | Base | 25 | 61 |
| filled channel, (%) | | | |

Polymer honeycomb parameters

| | | | |
|---|---|---|---|
| Channel length, l, (mm) | 100 | 100 | 100 |
| Width of square channel, S, (mm) | 10 | 10 | 10 |
| Wall thickness, w, (mm) | 3.4 | 3.4 | 3.4 |
| Specific heat, c_{w}, (kJ/kgK) | 1.8 | 1.8 | 1.8 |
| Density, ρ_{w}, (kg/m³) | 900 | 900 | 900 |
| Thermal conductivity, k_{w}, (W/mK) | 0.20 | 0.20 | 0.20 |
| Thermal diffusivity of the polymer | 1.23E−07 | 1.23E−07 | 1.23E−07 |
| composition, α_{w} = k_{w}/ρ_{w}c_{w}, (m²/s) | | | |
| Thermal diffusion length into the | 15 | 15 | 15 |
| channel wall from the surface, | | | |
| L_{w} = \sqrt{α_{w}tₚ}, (mm) | | | |

Here, it is desired to maintain the average temperature of the interior walls of the honeycomb structure below the characteristic polymer composition temperatures when at least one of these temperatures is below the ambient temperature, Tₐ, at which the interior walls quickly otherwise equilibrate. Because most of the honeycomb walls are interior walls, the mechanical integrity of the honeycomb is preserved during the paint bake cycle even if the exterior walls equilibrate at Tₐ. The solution should not add significant weight to, and should preserve acceptable mechanical performance of, the honeycomb in service.

If the aerogel remains in the channels after the honeycomb is put into service, the loose fit ensures that the mechanical performance of the honeycomb is not affected by the aerogel. However, the contribution of the aerogel to weight of the honeycomb in service can be considered. In Example 8, the channels have a square cross-section. In terms of the width, S, of one side of the square and the thickness, w, of interior walls, the ratio of aerogel volume to interior wall volume is about S/2w. The percent increase in weight of the honeycomb due to addition of the aerogel is about 100(ρₐ/ρ_{w})(S/2w) where ρₐ and ρ_{w} are the mass densities of the aerogel and the wall, respectively. In Example 8, the aerogel increases weight of the honeycomb structure by about 25%. It is noted that a carbon aerogel can be much lower in mass density than the aerogel in Example 8, and would result in a much lower percent increase in weight of the honeycomb.

Considering Example 9, the polyurethane foam of Example 9 is a typical foam as might be used in U.S. Pat. No. 8,322,780. Here parameters for the BETAFOAM™ 87100/87124 structural foam from Dow Automotive Systems, a polyurethane foam “for increasing stiffness of body structure cavities,” were used. This polyurethane foam is produced by the rapid mixing of BETAFOAM isocyanate and BETAFOAM polyol under high shear conditions. During vehicle assembly, these components are pumped at a controlled temperature into mixing equipment. The resulting foamy, viscous liquid is injected either manually or robotically into the inner cavities of the vehicle, conforming to the shape of the cavity. The primary purpose of this optional expanded structural foam in U.S. Pat. No. 8,322,780 is to provide the connection to the wall, for example, of the honeycomb structure, and thus the absorption of force and distribution of load.

When an aerogel fill insert is used, the fill insert has the advantage over the polyurethane foam in that the manufacturing of the article does not have to take into account the foaming reaction; the fill inserts can easily be removed and can be beneficial for later recycling of the polymer composition structure; and a non-homogeneous reinforcement effect can be achieved.

In Table 2, the polyurethane foam is characterized by a cured density of 374 kg/m³ which is in the range typical of structural foam of 300 to 600 kg/m³. Specific heat, mass density, and thermal conductivity are based on values disclosed in G Venkatesan et al., Measurement of thermophysical properties of polyurethane foam insulation during transient heating, Int. J. Therm. Sci. 40 (2001) 133-144. These are “free rise” values, i.e., for atmospheric pressure. They do not reflect the effects of pressure due to expansion of the foam in the confined volume of a channel. For example, thermal conductivity of polyurethane foam increases with increasing pressure above atmospheric pressure.

Table 2 indicates that polyurethane foam of Example 9 and silica aerogel of Example 8 can serve essentially the same thermal function during a paint bake cycle as they result in thermal diffusion lengths of 12 mm and 13 mm, respectively, that are less than the channel length, l. However, the aerogel adds less weight if left in place after paint bake cycle, of 61% and 25% for Examples 9 and 8, respectively. It is noted that if a loose fitting aerogel is used as the fill material, it affords the option of removing the fill material and its associated weight after the paint bake cycle. Such a removal step could not be easily performed for the expanded polyurethane foam.

It is noted that aerogels, as compared to polyurethane foams can optionally have a PCM incorporated therein. For example, silica aerogel skeletons have been laminated with organic polymer compositions as has been shown in N Leventis, Three-dimensional core-shell superstructures: mechanically strong aerogels, Acc. Chem. Res. 40 (2007) 874-884. It is further noted that if the melting temperature of organic polymer composition is less than Tₐ then it can serve as a shape-stabilized PCM.

Set forth below are some embodiments of the methods and articles disclosed herein.

Embodiment 1: A method of making an article, comprising: forming the article comprising first portion comprising a polymer composition and a second portion comprising a material, wherein the polymer composition has at least one of a heat deflection temperature, a melting temperature, a degradation temperature, and a glass transition temperature; and processing the article at a manufacturing temperature that is greater than a Temperature A, wherein the Temperature A is at least one of the heat deflection temperature, the melting temperature, the glass transition temperature, and the degradation temperature; wherein the polymer composition has a filled, channeled structure and/or wherein the article comprises a phase change material, wherein the presence of one or both of the filled, channeled structure and the phase change material maintains an average temperature of the polymer composition below Temperature B during the processing, wherein Temperature B is at least one of the heat deflection temperature, the melting temperature, the glass transition temperature, and the degradation temperature.

Embodiment 2: A method of making an article, comprising: forming the article comprising a first portion comprising a polymer composition and a second portion, wherein the polymer composition has at least one of a heat deflection temperature, a glass transition temperature, a melting temperature, and a degradation temperature, and wherein a composition of the first portion and of the second portion are different; and processing the article at a manufacturing temperature that is greater than a Temperature A, wherein the Temperature A is at least one of the heat deflection temperature, the melting temperature, the glass transition temperature, and the degradation temperature; wherein the first portion comprises at least one of (a) the polymer composition in the form of a filled, channeled structure and (b) a phase change material; wherein during the processing, an average temperature of the polymer composition is maintained below Temperature B, wherein Temperature B is at least one of the heat deflection temperature, the melting temperature, the glass transition temperature, and the degradation temperature.

Embodiment 3: The method of Embodiment 2, wherein during the processing, the average temperature of the polymer composition is maintained below Temperature B—5° C., or below Temperature B—10° C., or below Temperature B—20° C.

Embodiment 4: A method of making an article, comprising: forming the article comprising a first portion comprising a polymer composition having a polymer composition volume and a second portion, wherein the polymer composition has at least one of a heat deflection temperature, a melting temperature, a glass transition temperature, and a degradation temperature, and wherein a composition of the first portion and of the second portion are different; and processing the article at a manufacturing temperature that is greater than a Temperature A, wherein Temperature A is at least one of the heat deflection temperature, the melting temperature, the glass transition temperature, and the degradation temperature; wherein the first portion comprises at least one of (a) the polymer composition in the form of a filled, channeled structure, and (b) a phase change material; wherein, during the processing, greater than or equal to 50% of the polymer composition volume is maintained below Temperature B, wherein Temperature B is at least one of the heat deflection temperature, the melting temperature, the glass transition temperature, and the degradation temperature.

Embodiment 5: The method of claim 4, wherein during the processing, greater than or equal to 50% of the polymer composition volume is maintained below Temperature B—5° C., or below Temperature B—10° C., or below Temperature B—20° C.

Embodiment 6: The method of any of the preceding embodiments, wherein Temperature A, Temperature B, or both Temperature A and Temperature B, is the heat deflection temperature.

Embodiment 7: The method of any of the preceding embodiments, wherein Temperature A is the heat deflection temperature,

Embodiment 8: The method of any of the preceding embodiments, wherein Temperature B is the heat deflection temperature.

Embodiment 9: The method of any of the preceding embodiments, wherein Temperature A, Temperature B, or both Temperature A and Temperature B, is the melting temperature.

Embodiment 10: The method of any of the preceding embodiments, wherein Temperature A is the melting temperature,

Embodiment 11: The method of any of the preceding embodiments, wherein Temperature B is the melting temperature.

Embodiment 12: The method of any of the preceding embodiments, wherein Temperature A, Temperature B, or both Temperature A and Temperature B, is the degradation temperature.

Embodiment 13: The method of any of the preceding embodiments, wherein Temperature A is the degradation temperature,

Embodiment 14: The method of any of the preceding embodiments, wherein Temperature B is the degradation temperature.

Embodiment 15: The method of any of the preceding embodiments, wherein the article further comprises a thermal conductivity modifying additive mixed with the phase change material.

Embodiment 16: The method of any of the preceding embodiments, wherein the processing of the article comprises a paint-bake cycle.

Embodiment 17: The method of any of the preceding embodiments, wherein the processing of the article comprises welding, soldering, or both welding and soldering.

Embodiment 18: The method of any of the preceding embodiments, wherein the article is a portion of a vehicle.

Embodiment 19: The method of any of the preceding embodiments, wherein the polymer composition comprises the phase change material.

Embodiment 20: The method of Embodiment 19, wherein the phase change material is uniformly dispersed in the polymer composition.

Embodiment 21: The method of Embodiment 19, wherein the phase change material is localized near at least one surface of the polymer composition and optionally wherein the polymer composition comprises a region that is free of the phase change material.

Embodiment 22: The method of any of Embodiments 19-21, further comprising additional phase change material located in a PCM layer near a surface of the polymer composition.

Embodiment 23: The method of any of Embodiments 19-22, wherein the polymer composition further comprises a thermal conductivity modifying additive, wherein the thermal conductivity modifying additive optionally has a thermal conductivity of 0.01 to 100 W/mK, or 0.01 to 1 W/mK, or 0.01 to 0.5 W/mK, as measured at 23° C.

Embodiment 24: The method of any of Embodiments 1-18, wherein the phase change material is located in a PCM layer located near to a surface of the polymer composition.

Embodiment 25: The method of Embodiment 24, wherein the PCM layer is in physical contact with the surface.

Embodiment 26: The method of any of Embodiments 24-25, wherein the PCM layer has a greater concentration of phase change material near an inner surface of the PCM layer.

Embodiment 27: The method of Embodiment 26, wherein the PCM layer has an outer surface, and wherein greater than or equal to 60 wt % of the phase change material in the PCM layer is located closer to the inner surface than to the outer surface.

Embodiment 28: The method of Embodiment 17, wherein greater than or equal to 75 wt % of the phase change material in the PCM layer is located closer to the inner surface than to the outer surface.

Embodiment 29: The method of any of Embodiments 23-28, further comprising removing the PCM layer from the article after processing.

Embodiment 30: The method of any of Embodiments 24-29, wherein the PCM layer has an outer surface, and wherein, during processing, the outer surface is at the manufacturing temperature, and the inner surface is below Temperature B.

Embodiment 31: The method of any of the preceding embodiments, wherein the phase change material is encapsulated.

Embodiment 32: The method of any of the preceding embodiments, wherein the phase change material comprises zeolite powder, polytriphenylphosphate, crystalline paraffin wax, polyethyleneglycol, fatty acid, naphthalene, calcium bichloride, polyepsilon caprolactone, polyethylene oxide, polyisobutylene, polycyclopentene, polycyclooctene, polycyclododecene, polyisoprene, polyoxytriethylene, polyoxytetramethylene, polyoxyoctamethylene, polyoxypropylene, polybutyrolactone, polyvalerolactone, polyethyleneadipate, polyethylene suberate, polydecamethylazelate, or a combination comprising at least one of the foregoing.

Embodiment 33: The method of any of the preceding embodiments, wherein the polymer composition has a thermal conductivity of less than or equal to 0.3 W/mK.

Embodiment 34: The method of any of the preceding embodiments, wherein the polymer composition has the filled, channeled structure that is filled with a fill material.

Embodiment 35: The method of Embodiment 34, wherein the fill material has a thermal conductivity of less than or equal to 0.5 W/mK, specifically, less than or equal to 0.08 W/mK.

Embodiment 36: The method of any of Embodiments 34-35, wherein the fill material comprises an aerogel, wherein the aerogel optionally comprises greater than or equal to 90 vol % of air.

Embodiment 37: The method of Embodiment 36, wherein the aerogel comprises a silica aerogel, an alumina aerogel, a chromia aerogel, a zirconia aerogel, a vanadia aerogel, a neodynium oxide aerogel, a samarium oxide aerogel, a holmium oxide aerogel, an erbium oxide aerogel, a tin dioxide aerogel, a carbon aerogel, or a combination comprising one or more of the foregoing.

Embodiment 38: The method of any of Embodiments 34-37, wherein the fill material comprises the PCM.

Embodiment 39: The method of any of Embodiments 34-38, wherein the fill material forms a loose fit with surrounding channel walls.

Embodiment 40: The method of any of Embodiments 34-39, wherein the channeled structure comprises an array of circular channels, oval channels, square channels, rectangular channels, triangular channels, diamond channels, pentagonal channels, hexagonal channels, heptagonal channels, octagonal channels, irregular channels, as well as combinations comprising one or more of the foregoing.

Embodiment 41: The method of any of Embodiments 34-40, wherein the channeled structure has one or more of a channel density of 1 to 20 channels per 100 millimeter squared, a channel wall thickness of 0.5 to 10 mm, and a channel length of greater than or equal to 70 mm.

Embodiment 42: The method of any of Embodiments 34-41, further comprising removing the fill material prior to using the article.

Embodiment 43: The method of any of the preceding embodiments, wherein the polymer composition comprises a glass fiber filler.

Embodiment 44: The method of any of the preceding embodiments, wherein the first portion comprises the PCM and a thickness measured from a first surface to a second surface, and the method further comprises forming a phase change front into the first portion, wherein the phase change front extends through the thickness by less than or equal to 80%.

Embodiment 45: The method of Embodiment 44, wherein the phase change front extends from the first surface, through the thickness, by less than or equal to 70% and extends from the second surface, through the thickness, by less than or equal to 70%.

Embodiment 46: The method of any of Embodiments 44 and 45, wherein the phase change front extends from the first surface by less than or equal to 70%, specifically, less than or equal to 40%, more specifically, less than or equal to 30%.

Embodiment 47: The method of any of Embodiments 44-46, wherein the phase change front extends from the second surface by less than or equal to 50%, specifically, less than or equal to 35%, more specifically, less than or equal to 20%.

Embodiment 48: The method of any of Embodiments 44-47, wherein the phase change front obtains a penetration depth from the first surface of less than or equal to 5 mm, specifically, less than or equal to 3 mm, more specifically, less than or equal to 2 mm.

Embodiment 49: The method of Embodiment 48, wherein the phase change front obtains a penetration depth from the second surface of less than or equal to 2 mm, specifically, less than or equal to 1 mm, more specifically, less than or equal to 0.5 mm.

Embodiment 50: The method of any of the preceding embodiments, wherein the PCM has one or more of a latent heat of 100 to 600 kJ/kg or a melting temperature of less than the manufacturing temperature.

Embodiment 51: The method of any of the preceding embodiments, wherein the PCM is present in an amount of 1 to 50 wt % based on the total weight of the PCM and one or both of the polymer composition and the fill material.

Embodiment 52: The method of any of the preceding embodiments, wherein the polymer composition has one or more of a specific heat of 0.1 to 3.5 kJ/kg, a mass density of 800 to 2,200 kg/m³, a thermal conductivity of 0.1 to 0.5 W/mK as measured at 23° C., and a thermal diffusivity of less than or equal to 3×10⁻⁵ m/s².

Embodiment 53: An article produced by a method of the preceding embodiments.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

All ranges disclosed herein are inclusive of the endpoints, and the endpoints are independently combinable with each other (e.g., ranges of “up to 25 weight %, or, more specifically, 5 weight % to 20 weight %”, is inclusive of the endpoints and all intermediate values of the ranges of “5 weight % to 25 weight %,” etc.). “Combination” is inclusive of blends, mixtures, alloys, reaction products, and the like. Furthermore, the terms “first,” “second,” and the like, herein do not denote any order, quantity, or importance, but rather are used to differentiate one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and can optionally be present in other embodiments. “Optional” or “optionally” means that the subsequently described event or circumstance can or cannot occur, and that the description includes instances where the event occurs and instances where it does not.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group. In addition, it is to be understood that the described elements can be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

What is claimed is:

1. A method of making an article, comprising:
forming the article comprising a first portion comprising a polymer composition and a second portion, wherein the polymer composition has at least one of heat deflection temperature, a glass transition temperature, a melting temperature, and a degradation temperature, and wherein a composition of the first portion and of the second portion are different; and
processing the article at a manufacturing temperature that is greater than a Temperature A, wherein the Temperature A is at least one of the heat deflection temperature, the melting temperature, the glass transition temperature, and the degradation temperature;
wherein the first portion comprises at least one of
the polymer composition in the form of a filled, channeled structure, and
a phase change material;
wherein during the processing, an average temperature of the polymer composition is maintained below Temperature B, wherein Temperature B is at least one of the heat deflection temperature, the melting temperature, the glass transition temperature, and the degradation temperature.

2. The method of claim 1, wherein during the processing, the average temperature of the polymer composition is maintained below Temperature B—5° C., or below Temperature B—10° C., or below Temperature B—20° C.

3. A method of making an article, comprising:
forming the article comprising a first portion comprising a polymer composition having a polymer composition volume and a second portion, wherein the polymer composition has at least one of a heat deflection temperature, a melting temperature, a glass transition temperature, and a degradation temperature, and wherein a composition of the first portion and the second portion are different; and
processing the article at a manufacturing temperature that is greater than a Temperature A, wherein Temperature A is at least one of the heat deflection temperature, the melting temperature, the glass transition temperature, and the degradation temperature;
wherein the first portion comprises at least one of
the polymer composition in the form of a filled, channeled structure, and
a phase change material;
wherein, during the processing, greater than or equal to 50% of the polymer composition volume is maintained below Temperature B, wherein Temperature B is at least one of the heat deflection temperature, the melting temperature, the glass transition temperature, and the degradation temperature.

4. The method of claim 3, wherein during the processing, greater than or equal to 50% of the polymer composition volume is maintained below Temperature B—5° C., or below Temperature B—10° C., or below Temperature B—20° C.

5. The method of claim 1, wherein the polymer composition has a thermal conductivity of less than or equal to 0.3 W/mK.

6. The method of claim 1, wherein the article further comprises a thermal conductivity modifying additive mixed with the phase change material.

7. The method of claim 1, wherein the processing of the article comprises at least one of a paint-bake cycle, welding, and soldering.

8. The method of claim 1, wherein the polymer composition comprises the phase change material.

9. The method of claim 8, wherein the phase change material is localized near at least one surface of the polymer composition and optionally wherein the polymer composition comprises a region that is free of the phase change material.

10. The method of claim 1, the polymer composition further comprising a thermal conductivity modifying additive.

11. The method of claim 1, wherein the phase change material is located in a PCM layer located near to a surface of the polymer composition, and wherein the PCM layer is optionally in physical contact with the surface.

12. The method of claim 11, wherein the PCM layer has a greater concentration of phase change material near an inner surface of the PCM layer, and wherein the inner surface is adjacent to the polymer composition.

13. The method of claim 11, wherein the PCM layer has an outer surface, and wherein, during processing, the outer surface is at the manufacturing temperature, and the inner surface is below Temperature A.

14. The method of claim 1, wherein the phase change material comprises zeolite powder, polytriphenylphosphate, crystalline paraffin wax, polyethyleneglycol, fatty acid, naphthalene, calcium bichloride, polyepsilon caprolactone, polyethylene oxide, polyisobutylene, polycyclopentene, polycyclooctene, polycyclododecene, polyisoprene, polyoxytriethylene, polyoxytetramethylene, polyoxyoctamethylene, polyoxypropylene, polybutyrolactone, polyvalerolactone, polyethyleneadipate, polyethylene suberate, polydecamethylazelate, or a combination comprising at least one of the foregoing.

15. The method of claim 1, wherein the polymer composition has the filled, channeled structure that is filled with a fill material, wherein the fill material has a thermal conductivity of less than or equal to 0.5 W/mK.

16. The method of claim 15, wherein the fill material comprises an aerogel.

17. The method of claim 16, wherein the aerogel comprises a silica aerogel, an alumina aerogel, a chromia aerogel, a zirconia aerogel, a vanadia aerogel, a neodynium oxide aerogel, a samarium oxide aerogel, a holmium oxide aerogel, an erbium oxide aerogel, a tin dioxide aerogel, a carbon aerogel, or a combination comprising one or more of the foregoing.

18. The method of claim 15, wherein the fill material comprises the phase change material.

19. The method of claim 15, wherein the fill material forms a loose fit with surrounding channel walls.

20. (canceled)

21. An article produced by the methods of claim 1.
